(19) United States
(12) Patent Application Publication
(10) Pub. No.: US 2006/0195838 A1
(43) Pub. Date: Aug. 31, 2006

(54) Limiting distribution of copy-protected material to geographic regions

(75) Inventor: Michael A. Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/548,217

(22) PCT Filed: Feb. 25, 2004
(86) PCT No.: PCT/IB04/00559

§ 371 Date: Sep. 2, 2005

Related U.S. Application Data
(60) Provisional application No. 60/451,919, filed on Mar. 4, 2003.
(60) Provisional application No. 60/484,555, filed on Jul. 2, 2003.

(51) Int. Cl. G06F 9/445

(52) U.S. Cl. 717/174; 717/168

(57) ABSTRACT

A method and system (200) marks (170) a copy of copy-protected material (202) with a geographic marker based on a geographic region of the source of the copy. Conforming rendering devices are configured to prevent (140) the rendering of copy protected material (201) that have geographic markers that differ (120) from the geographic region associated with the rendering device. Any of a variety of techniques are used to determine the geographic location of the rendering device (200), including the geographic location of the rendering device that produces the original copy. Preferably, each copy (202) of the copy-protected material also includes an identifier of the rendering device (200) that produced the copy, and subsequent renderings of copies by the same rendering device are permitted (130) regardless of geographic locale, thereby allowing for the relocation of a consumer's rendering devices and libraries of material.

This application claims the benefit of U.S. provisional patent application 60/451,919, filed on 4 Mar. 2003.

This invention relates to the field of copy protection, and in particular to the prevention of distribution of copy-protected material to distant or global markets.

Copy protection provides the owner of copyright material, such as entertainment material, from unauthorized distribution of the material. Purchasers of copyright material, however, expect to be able to copy the purchased material for their own convenience and enjoyment. Standards and techniques continue to evolve to provide copy protection systems that allow purchasers of protected material to freely copy the material, yet still provide the owner of the protected material some protection from widescale distribution.

Of particular concern to owners of copyright material is the potential of widescale distribution of the material via the Internet. Heretofore, individuals had limited opportunity to widely distribute material, and legal recourse could be pursued against the relatively few widescale purveyors of illicit copies of copyright material. Augmenting the inherent widescale connectivity provided by the Internet, web-sites have been established to specifically facilitate the widescale distribution of entertainment material.

A variety of protection schemes have been proposed and/or implemented that attempt to balance the competing rights of the purchasers and owners of copyright material. A common technique used in many of these protection schemes is the use of a marking of the material that is sensitive to a change to the content material. For example, a mark can be created that is based on a hash value of the authorized content material. If the content is modified in any way, the mark will no longer correspond to a hash value of the modified content. By indelibly bonding the mark to the content material, via, for example, an electronic watermarking process, modified copies of the content material can be detected. Such a marking is particularly effective in detecting an Internet-distribution of the material, because the compression techniques that are commonly used to efficiently transmit information over the Internet introduce changes to the material.

These compression-detection techniques, however, are ineffective if the user is willing to accept the time required to transmit the material, and the willingness of a user to accept the time required can be expected to increase as the bandwidth available to users increases. Also, these compression-detection techniques may be ineffective if the material is originally provided without a marking that is configured to facilitate detection of a subsequent compression.

It is an object of this invention to provide a copy-protection scheme that limits the range of distribution of copy-protected material. It is a further object of this invention to provide a copy-protection scheme is substantially independent of the copy-protection provided by the source material.

These objects, and others, are provided by a method and system that marks a copy of copy-protected material with a geographic marker based on a geographic region of the source of the copy. Conforming rendering devices are configured to prevent the rendering of copy-protected material that have geographic markers that differ from the geographic region associated with the rendering device. Any of a variety of techniques are used to determine the geographic location of the rendering device, including the geographic location of the rendering device that produces the original copy. Preferably, each copy of the copy-protected material also includes an identifier of the rendering device that produced the copy, and subsequent renderings of copies by the same rendering device are permitted regardless of geographic locale, thereby allowing for the relocation of a consumer's rendering devices and libraries of material.

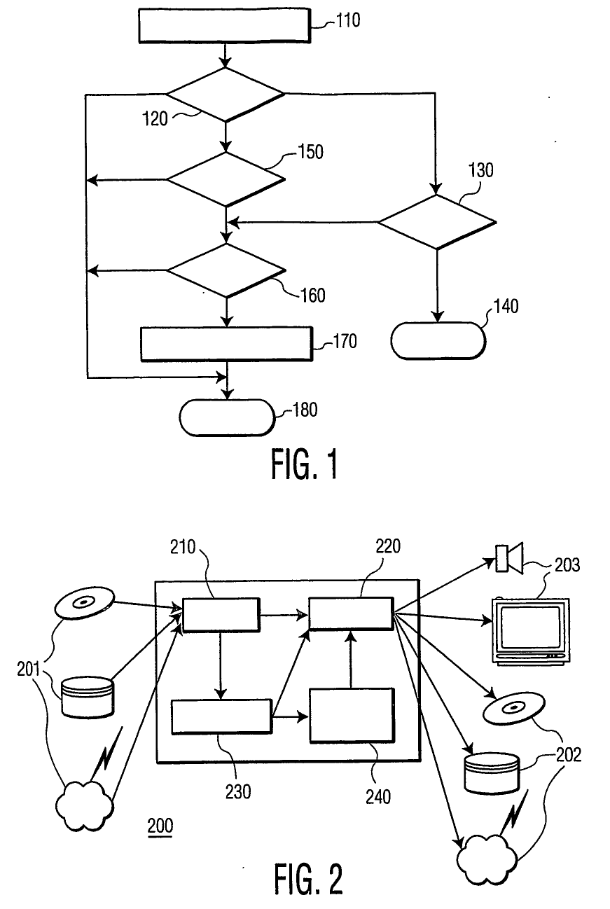

FIG. 1 illustrates an example flow diagram of a copy protection system in accordance with this invention.

FIG. 2 illustrates an example block diagram of a copy protection system in accordance with this invention.

Throughout the drawings, the same reference numeral refers to the same element, or an element that performs substantially the same function.

FIG. 1 illustrates an example flow diagram of a copy protection system in accordance with this invention. At 110, a rendering device receives a request to render content material. For the purposes of this invention, the term rendering includes any and all processes that access and process the content material, including but not limited to: copying, playing, displaying, and so on. Similarly the term copying includes any and all processes that produce a copy of the content material in any of a variety of forms, including storing the material, providing the material on a removable storage device, transmitting the material to a remote device, and so on.

In accordance with this invention, the content material optionally includes a geographic marker that identifies the source of this copy of the content material. At 120, the content material is checked to determine whether it has an associated geographic marker, and if so, whether the geographic marker corresponds to the location of the rendering device. It is assumed herein that the presence of a geographic marker implies a restriction of rendering the material to rendering device located within a geographic region corresponding to the geographic marker. For example, material that is broadcast to a particular region, or within a particular country, may be marked to restrict its subsequent redistribution to other regions or countries. Any of a variety of techniques can be used to identify the location of the rendering device, as detailed further below. If, at 120, the marker corresponds to the locale of the rendering device, the material is rendered, at 180.

If, at 120, the material is determined not to contain a geographic marker, it is checked, at 150, to determine if it contains any other marking that indicates that the material should be protected. For example, the material may be identified as protected “Broadcast” material that should not be redistributed. In like manner, a default rule could be established wherein if the material contains any form of a copy-protect marking, any copies made be marked to limit redistribution based on geographic locale. If, at 150, the material contains no indication of being copy-protected, or the request is not to make a copy of the material, at 160, it is freely rendered, at 180. If, at 150, the material is determined to warrant copy-protection, and, at 160, the request is to copy the material, a geographic marker corresponding to the location of the rendering device is attached to the material, at 170, and the material is rendered/copied, at 180.

In accordance with a second aspect of this invention, the content material also includes an identifier of the source of this copy of the material. If, at 120, the geographic marker indicates a source locale that differs from the locale of the rendering device, the content material is optionally checked to determine its source. If the source of the material is this rendering device, then the fact that the source locale and the current locale do not correspond is ignored, and the process continues at 160, or, optionally at 180, as discussed below. In this manner, if the consumer relocates to a new geographic location, the consumer is still able to access any of the material that was created by this rendering device. If, on the other hand, the locales differ, at 120, and the source of the material is not the current rendering device, at 130, the rendering is refused, at 140.

As noted above, if, at 130, the rendering device is the same device as the source of the copy, but its locale has changed, the process continues at 160, and thus the new copy will be marked with the current geographic marker of the rendering device. Although this scheme would allow an illicit copier to create copies that are renderable at multiple geographic locations by shipping the rendering device to each geographic locale to make different copies, it provides a relatively transparent means of maintaining a consumer's right to copy material when the consumer changes locations. Optionally, if it is determined that the risk of the aforementioned illicit copying exceeds the need to maintain the consumer's rights after relocation, the process can be structured to merely render the material with the original geographic marker, by branching from block 130 to 180, thereby bypassing the application of the new geographic marker at 160.

FIG. 2 illustrates an example block diagram of a copy protection system 200 in accordance with this invention. The system 200 is configured to read content material from media 201 via a reader 210, and rendering the material to produce a visual or audio output to devices 203, or to provide a copy of the material to media 202, via a renderer 220. The media 201 and 202 may include a removable media such as a CD or DVD, a fixed media such as a hard-disk drive, or a less tangible media such as a network or broadcast connection to a remote source or a remote destination. For the purposes of this disclosure, a broadcast of material to potential receivers, for example, via cable, satellite, or direct broadcast, constitutes providing a copy of the material, regardless of whether a particular receiver receives the material and/or makes a copy of the material.

In accordance with this invention, the system 200 includes a geographic checker 230 that is configured to compare a geographic marker associated with the content material to the geographic location of the system 200. The geographic marker is preferably included in a watermark or other indelible data that is affixed to the content material.

The geographic marker is configured to identify a geographic region, and may be based on delimiters such as time-zones, national boundaries, continental boundaries, regional boundaries, postal boundaries, and so on. For example, when a subscriber orders a pay-per-view movie, the content material may include a geographic marker that is based on the subscriber's zip-code, telephone number, time-zone, city, state, or other identifier of a locale to which the material is being transferred. Thereafter, only rendering devices that are located in the corresponding locale will subsequently render the material or copies of the material. The term ‘corresponding locale’ is defined herein as conforming to a geographic bound associated with the marker. For example, the marker may identify a time-zone, and a corresponding locale may be any locale within N time-zones of the identified time-zone. Or, the identifier may be a coordinate, and a corresponding locale may be a location within a radius R of the coordinate. In like manner, the identifier may be a country-identifier and a corresponding locale may be any of a list of countries having a political, social, or economic relationship with the identified country, and so on.

The geographic location of the system 200 may be identified in any of a variety of means, as will be evident to one or ordinary skill in the art in view of this disclosure. In a straightforward embodiment, a manufacturer of the system 200 may include a country identifier that identifies the country to which the system 200 is shipped for distribution. In a preferred embodiment, the system 200 has access to a means of determining a geographic location. Many receiving devices, such as satellite and cable set-top boxes require access to a telephone, and use the telephone connection to detect a change of location of the receiving device. Many software applications require an initial access authorization sequence, via a cable or telephone communication with a provider, and this sequence could be configured to include a location identifier. Other means of determining location, such as GPS, reception of locale information from a broadcast signal, or other techniques, may also be used.

If automated means of determining location are not available or not suitable for embodiment in the system 200, manual techniques may be used. For example, the consumer may be required to enter a zip-code to initially activate the system 200. Thereafter, this zip-code is used to identify the locale of the system 200. Although this method of identifying the locale of the system 200 is subject to potential abuse by an illicit copier, it serves to protect the content material from widespread distribution by ‘unintentional’ illicit copiers. That is, most consumers do not want to be prevented from copying material for their own use, but are not, per se, inclined to take an active role in circumventing unobtrusive protection schemes such as the scheme of this invention. Alternatively, obstacles can be embodied to reduce the ease of abuse of the system. For example, a user of the system 200 can be prevented from changing the initially entered location identifier without contacting an authorizing authority for an access code. The authorizing authority can be configured to limit the number of times a consumer is permitted to change location identifiers within a given time period. Alternatively or additionally, as noted above, each copy is preferably marked with an identifier of the source device, and when an abuse is detected, the authorizing authority can refuse to grant subsequent location-change authorizations to the abusing device. These and other techniques of facilitating and controlling the determination of the geographic location of the system 200 will be evident to one of ordinary skill in the art in view of this disclosure.

The geographic checker 230 is configured to control the renderer 220 based on the correspondence between the geographic marker in the material from the media 201 and the geographic locale of the system 200. If the marker and locale correspond, as defined above, or if there is no geographic marker in the material, the checker 230 enables the renderer 220.

If the marker and locale do not correspond, the geographic checker 230 optionally checks an identifier of the source of the material to determine whether this system 200 previously created the content material on the media 201. One of ordinary skill in the art will recognize that the content material on the media 201 may include an identifier of the system 200, or the system 200 may include an identifier of each content material on media 202 that this system previously produced. For ease of understanding and presentation, the term “identifier of the source” includes either of these identification techniques. If this system 200 is the source of the material on the media 201, the geographic checker 230 is configured to enable the renderer 220, independent of the correspondence between geographic marker and the locale of the system 200.

If the system 200 is able to render copies of the material to media 202, the system 200 preferably includes a marking device 240 that selectively marks each copy that it produces. As noted above, if the material on the media 201 does not contain a geographic marker, but is identified as being copy-protected, the marking device 240 is configured to add a geographic marker to the material that is provided to the media 202. If the material on the media 201 contains a geographic marker that corresponds to the locale of the system 200, this original geographic marker is included in the material that is provided to the media 202. If the material on the media 201 contains a geographic marker that does not correspond to the locale of the system 200, and the system 200 is identified as the source of the material on the media 201, the system 200 is configured to either retain the original marker or apply a new marker corresponding to the new location of the system 200, as discussed above.

The marking device 240 is also configured to optionally identify the system 200 as the source of the material that is provided to the media 202, either by marking the material with the identifier of the system 200, or by storing an identifier of the material on the media 202 in the system 200, or at a remote location accessible to the system 200, such as a network database.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented in the context of a typical consumer rendering device, the invention is applicable to any system that is configured to provide copies of protected material. For example, the system 200 could be located in a conventional television, cable, or satellite broadcast station, wherein the renderer 220 includes a transmitter that broadcasts the material to remote receivers. In such an embodiment, the marking device 240 is configured to mark the broadcast material with a geographic marker corresponding to the locale of the intended recipients, which may or may not actually correspond to the locale of the broadcast station. These and other system configuration and optimization features will be evident to one of ordinary skill in the art in view of this disclosure, and are included within the scope of the following claims.

1. A method of copy-protection, comprising:
receiving content material at a rendering system (200),
determining (120) whether the content material includes a geographic marker,
rendering (180) the content material based on a correspondence between the geographic marker and an identified locale of the rendering system (200).

2. The method of claim 1, further including
determining the identified locale of the rendering system (200).

3. The method of claim 1, further including
marking (170) a copy of the content material with a new geographic marker corresponding to the identified locale of the rendering system (200).

4. The method of claim 3, further including
marking the copy of the content material with an identification of the rendering system (200).

5. The method of claim 1, wherein
the geographic marker is included in a watermark that is bound to the content material.

6. The method of claim 1, wherein
the content material includes an identification of a source of the content material, and
the method further includes
rendering (130-180) the content material if the identification of the source corresponds to an identification of the rendering system (200).

7. A copy-protection system (200), comprising:
a renderer (220) that is configured to selectively render content material, and
a geographic checker (230), operably coupled to the renderer (220), that is configured to control the renderer (220) based on a correspondence between a geographic marker of the content material and an identified locale of the system (200).

8. The system (200) of claim 7, further including
a reader (210), operably coupled to the renderer (220), that is configured to receive the content material.

9. The system (200) of claim 8, wherein
the reader (210) is further configured to provide the geographic marker to the geographic checker (230).

10. The system (200) of claim 7, further including
a marking device (240), operably coupled to the renderer (220), that is configured to add a new geographic marker corresponding to the locale of the system (200) to a copy of the content material provided by the renderer (220).

11. The system (200) of claim 10, wherein
the marking device (240) is further configured to add an identifier of the system (200) to the copy of the content material.

12. The system (200) of claim 10, wherein
the renderer (220) is further configured to store an identification of the copy of the content material.

13. The system (200) of claim 7, wherein
the geographic checker (230) is further configured to control the renderer (220) based on a correspondence between an identifier of a source of the content material and an identifier of the system (200).

14. A copy-protection system (200) comprising
a transmitter (220) that is configured to transmit material to one or more receivers, and
a marking device (240) that is configured to mark the material with a geographic marker that corresponds to a locale of the one or more receivers.

15. The copy-protection system (200) of claim 14, wherein
the geographic marker is included in a watermark that is bound to the material.

16. The copy-protection system (200) of claim 14, further including
at least one receiver of the one or more receivers that is configured to control rendering of the material based on a correspondence between the geographic marker and a location of the at least one receiver.
